(19) United States
(12) Patent Application Publication
(10) Pub. No.: US 2021/0386262 A1
(43) Pub. Date: Dec. 16, 2021

(54) METHOD OF SURFACE TYPE DETECTION AND ROBOTIC CLEANER CONFIGURED TO CARRY OUT THE SAME

(71) Applicant: SHARKNINJA OPERATING LLC, Needham, MA (US)

(72) Inventors: Brendan C. UCHENDU, Boston, MA (US); Christopher PINHEIRO, East Walpole, MA (US)

(21) Appl. No.: 17/345,695

(22) Filed: Jun. 11, 2021

Related U.S. Application Data
(60) Provisional application No. 63/038,425, filed on Jun. 12, 2020.

(51) Int. Cl. A47L 9/28; A47L 9/04; G05D 1/02; G06F 16/29; G06F 16/28

(52) U.S. Cl. CPC A47L 9/2826; A47L 9/2852; A47L 9/2847; A47L 9/0411; A47L 2201/06; G05D 1/0238; G06F 16/29; G06F 16/285; A47L 2201/04; A47L 9/0466

(57) ABSTRACT

A method of surface type detection may include traversing a cleaning area, generating a plurality of cluster points while traversing the cleaning area, each cluster point being associated with a corresponding surface type and a location, and determining at least one surface type region within the cleaning area based, at least in part, on a comparison of the plurality of cluster points.

### CROSS-REFERENCE TO RELATED APPLICATIONS

The present application claims the benefit of U.S. Provisional Application Ser. No. 63/038,425 filed on Jun. 12, 2020, entitled Robotic Vacuum Cleaner having Surface Type Detection using Sensor Fusion, which is fully incorporated herein by reference.

### TECHNICAL FIELD

The present disclosure is generally directed to surface treatment apparatuses and more specifically to a robotic cleaner.

### BACKGROUND INFORMATION

Mobile robotic devices can include robotic cleaners. A robotic cleaner is configured to autonomously travel about a surface while collecting debris left on the surface. A robotic cleaner can be configured to travel along a surface according to a random and/or predetermined path. When traveling along a surface according to the random path, the robotic cleaner may adjust its travel path in response to encountering one or more surface types. When traveling along a surface according to a predetermined path, the robotic cleaner may have, in prior operations, developed a map of the area to be cleaned and travel about the area according to a predetermined path based on the map. Regardless of whether the robotic cleaner is configured to travel according to a random or predetermined path, the robotic cleaner may be configured to travel in predetermined patterns. For example, a robotic cleaner may be positioned in a location with an area rug and be caused to enter a cleaning pattern that causes the robotic cleaner to clean only the area rug.

The robotic cleaner can include one or more sensors for detecting one or more conditions of a surrounding environment. For example, the robotic cleaner can include one or more surface-type detection sensors configured to detect one or more properties of a surface (e.g., a floor). In some instances, the output data generated by the one or more surface type detection sensors may suffer from erroneous outputs (e.g., a false positive that erroneously indicates a change in surface type). Erroneous outputs may be the result of, for example, noise in the output data, clutter on the surface (e.g., one or more electrical cords), and/or reflectivity of the surface. Erroneous outputs may cause the mobile robotic cleaner to expend additional computational resources in obstacle avoidance (e.g., stopping and/or changing its route) and may display behavior that a user would interpret as unintelligent.

### BRIEF DESCRIPTION OF THE DRAWINGS

These and other features and advantages will be better understood by reading the following detailed description, taken together with the drawings, wherein:

FIG. 1 is a schematic bottom view of an example of a robotic cleaner, consistent with embodiments of the present disclosure.

FIG. 2A is a schematic block diagram of a circuit configured to determine a surface type, consistent with embodiments of the present disclosure.

FIG. 2B is flow chart of an example method of determining a surface type, consistent with embodiments of the present disclosure.

FIG. 3 is a bottom view of a wet/dry robotic cleaner, consistent with embodiments of the present disclosure.

FIG. 4 is vertical cross-sectional view of an example of a surface type sensor of the wet/dry robotic cleaner of FIG. 3, consistent with embodiments of the present disclosure.

FIGS. 5A shows a schematic representation of a portion of a method of surface type detection and labelling, consistent with embodiments of the present disclosure.

FIG. 5B shows a schematic representation of another portion of the method of FIG. 5A, consistent with embodiments of the present disclosure.

FIG. 5C shows a schematic representation of another portion of the method of FIG. 5A, consistent with embodiments of the present disclosure.

FIG. 5D shows a schematic representation of another portion of the method of FIG. 5A, consistent with embodiments of the present disclosure.

FIG. 6 is a flow chart of an example of a method of surface type detection, consistent with embodiments of the present disclosure.

FIG. 7A is a flow chart of an example of a method of surface type detection using multiple sensor inputs, consistent with embodiments of the present disclosure.

FIG. 7B is flow chart of another example of the method of FIG. 7A, consistent with embodiments of the present disclosure.

FIG. 8 is a flow chart of an example of a robot cleaner behavior using a dynamic method of surface type detection, consistent with embodiments of the present disclosure.

### DETAILED DESCRIPTION

The present disclosure is generally directed to a robotic cleaner (e.g., a robotic vacuum cleaner). The robotic cleaner may include a suction motor configured to generate suction at an air inlet, at least one side brush coupled to a side brush motor, the side brush being configured to urge debris on a surface towards the air inlet, a dust cup for collecting debris urged into the air inlet, and a surface type sensor. The robotic cleaner is configured to detect a surface type based, at least in part, on an output of the surface type sensor.

In operation, the robotic cleaner may include a controller configured to receive sensor inputs at least from the surface type sensor. The controller may be configured to analyze the inputs received from the surface type sensor to determine a first surface type corresponding to the sensor input and to associate the determined surface type with a location of the robotic cleaner. The first determined surface type can then be compared to one or more additional determined surface types corresponding to locations that are proximate to the location associated with the first determined surface type. For example, the first determined surface type can be compared to additional surface type determinations, each associated with a respective location within an area around the robotic cleaner. Based on the comparison, the controller may determine whether the first determined surface type is an accurate representation of the surface type. In other words, the controller may generally be described as being configured to filter out erroneous input data received from surface type sensor.

In some embodiments, the controller may be further configured to receive inputs from one or more additional sensors (e.g., sensors monitoring motor currents, drop-off/cliff sensors, and/or any other sensor) to generate a second surface type determination that is associated with a location of the robotic cleaner. The second determined surface type can be compared to one or more additional surface type determinations corresponding to locations that are proximate to the location associated with the second determined surface type. For example, the second determined surface type can be compared to additional surface type determinations, each associated with a respective location within an area around the robotic cleaner. Based on the comparison, the controller may determine whether the second determined surface type is an accurate representation of the surface type.

In some instances, the first determined surface type and second determined surface type may be compared to generate a composite surface type determination. The composite surface type determination may be associated with a confidence level. For example, when the first and second surface type determinations correspond to the same surface type, the composite surface type determination corresponds to the surface type of both the first and second surface type determinations and may be associated with a high confidence level. By way of further example, when the first and second surface type determinations do not correspond to the same surface type, a reliability factor may be associated with the first and second surface type determinations and the composite surface type determination corresponds to the surface type determination having the highest reliability factor. In this example, the composite surface type determination may be associated with a low confidence level.

In some embodiments an integration module may generate a surface type map based on one or more of the first, second, and/or composite surface type determinations. For example, the map may include a plurality of composite surface type determinations, each corresponding to respective locations, wherein a confidence level is associated with each composite surface type determination. In this example, the map may be presented to a user, wherein the confidence level is represented to the user as a color (e.g., green for high confidence level and red for a low confidence level). The user may be able to confirm the accuracy of the composite surface type determinations, which may result in improving confidence levels associated with each of the composite surface type determinations. By way of further example, the map may include a plurality of first surface type determinations corresponding to respective locations. The user may be able to confirm the accuracy of the first surface type determinations. The surface type map can be used for automatically guiding and controlling the behavior of the mobile robotic device.

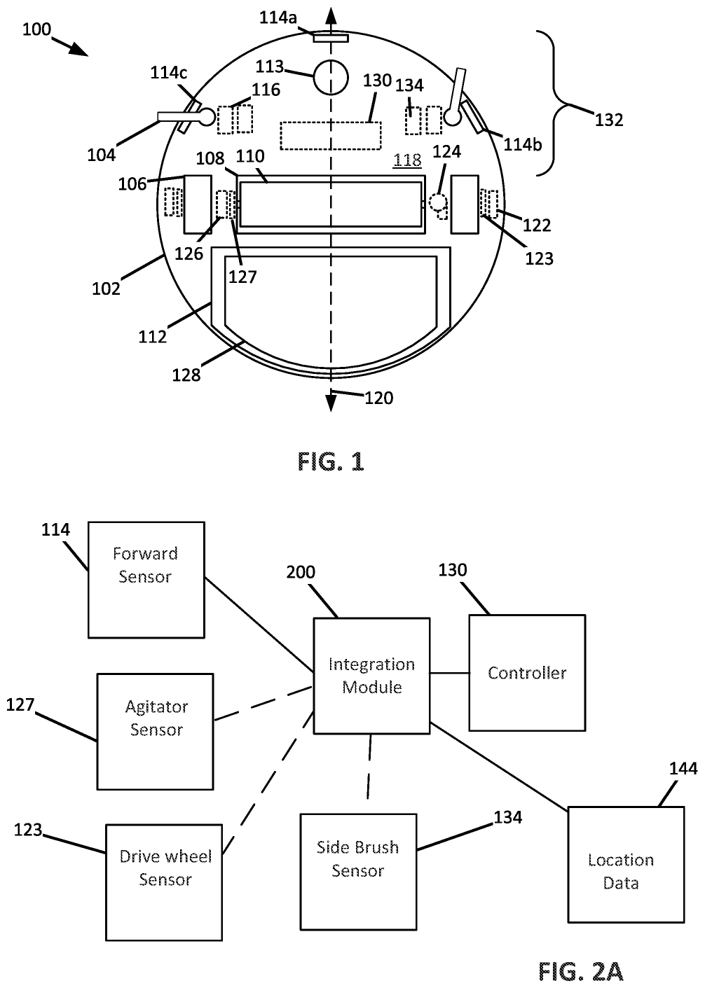

FIG. 1 shows a schematic bottom view of a robotic cleaner 100. As shown, the robotic cleaner 100 includes a main body 102, one or more side brushes 104 rotatable relative to the main body 102, one or more drive wheels 106 coupled to the main body 102 and configured to urge the robotic cleaner 100 over a surface to be cleaned, an air inlet 108 having a rotatable agitator 110 disposed therein, a dust cup 112, a non-driven supporting wheel 113 (e.g., a caster wheel), and one or more forward sensors 114 coupled to the main body 102. The one or more forward sensors 114 may include bump sensors, obstacle detection sensors, side wall sensors, optical sensors, or cliff sensors.

The one or more side brushes 104 may be driven by a corresponding side brush motor 116 (shown in hidden lines) disposed within the main body 102. Activation of the side brush motor 116 causes a corresponding rotation in a respective side brush 104 about an axis (e.g., that extends substantially perpendicular to a bottom surface 118 of the main body 102). Rotation of the one or more side brushes 104 urges debris on a surface to be cleaned (e.g., a floor) towards a central axis 120 of the main body 102, wherein the central axis 120 extends parallel to a direction of forward movement of the robotic cleaner. In other words, rotation of the one or more side brushes 104 urges debris on a surface to be cleaned (e.g., a floor) towards the air inlet 108. The side brush motor 116 may be associated with the side brush sensor 134. The side brush sensor 134 can be configured to determine an amount of current or torque associated with operation of the side brush motor 116.

The one or more drive wheels 106 may be driven by a corresponding drive motor 122 (shown in hidden lines). One or more drive wheel sensors 123 can be associated with the drive motor 122. The one or more drive wheel sensors 123 may include, for example, an encoder or a current sensor. Activation of the drive motor 122 causes a corresponding rotation in a respective drive wheel 106. Differential rotation of a plurality of drive wheels 106 can be used to steer the robotic cleaner 100 over the surface to be cleaned.

The air inlet 108 can be fluidly coupled to a suction motor 124. The suction motor 124 is configured to cause a suction force to be generated at the air inlet 108 such that debris deposited on the surface to be cleaned can be urged into the air inlet 108. The rotatable agitator 110 can be driven by a corresponding agitator motor 126. One or more agitator motor sensors 127 can be associated with the agitator motor 126. The one or more agitator sensors 127 can be configured to detect a torque of the agitator motor 126 and/or a current draw of the agitator motor 126. The one or more agitator motor sensors 127 may include, for example, an encoder or a current sensor. Rotation of the rotatable agitator 110 may cause at least a portion of the rotatable agitator 110 to engage the surface to be cleaned and dislodge at least a portion of debris deposited thereon. Dislodged debris may then be suctioned into the air inlet 108 as a result of the suction generated by the suction motor 124.

The dust cup 112 is fluidly coupled to the air inlet 108 and the suction motor 124 such that at least a portion of debris suctioned into the air inlet 108 can be deposited within the dust cup 112. The dust cup 112 may also include a pad 128 that is removably coupled thereto. The pad 128 may be configured to receive a liquid such that the robotic cleaner 100 can engage in wet cleaning.

As shown, the robotic cleaner 100 may include a leading forward sensor 114a, a left forward sensor 114b, and a right forward sensor 114c. The forward sensors 114 may be configured to detect one or more surface conditions. The one or more surface conditions may include one or more of a surface type (e.g., carpeted, hard floor, and the like), non-traversable drop-offs/cliffs, and/or any other surface condition.

The left forward sensor 114b and the right forward sensor 114c may be disposed on opposite sides of the central axis 120 of the main body 102 and the leading forward sensor 114a may be positioned such that the central axis 120 extends through the leading forward sensor 114a. However, other configurations are possible. For example, the robotic cleaner 100 may include only the left and right forward sensors 114b and 114c arranged on opposite sides of the central axis 120 of the main body 102. By way of further example, the robotic cleaner 100 may include only the leading forward sensor 114a arranged on the central axis 120 such that the central axis 120 extends through the leading forward sensor 114a. The inclusion of the left and right forward sensors 114b and 114c allows the robotic cleaner 100 to determine (e.g., using a controller 130) an orientation of the robotic cleaner 100 relative to a transition in surface type (e.g., such that the robotic cleaner 100 can be controlled to follow the transition in surface type).

The forward sensors 114a, 114b, and 114c can be coupled to and arranged around a periphery of the main body 102 of the robotic cleaner 100. For example, and as shown, the forward sensors 114a, 114b, and 114c can be arranged about the periphery of a forward portion 132 of the main body 102. The forward portion 132 corresponds to the portion of the main body 102 extending from the one or more drive wheels 106 and in a direction of the one or more side brushes 104.

By arranging the forward sensors 114a, 114b, and 114c along the periphery of the forward portion 132 of the main body 102, the robotic cleaner 100 may be capable of detecting a transition in surface type before the robotic cleaner 100 traverses the transition in surface type (e.g., one or more drive wheels 106 traverse the transition). For example, the robotic cleaner 100 can be configured to avoid traversing the transition in the surface type. As such, one or more of the cleaning implements (e.g., the rotatable agitator 110 or the pad 128) may be prevented from traversing the transition in surface type. This may prevent, for example, a wet pad 128 from contacting a carpeted surface (potentially preventing damage to the carpeted surface). In some instances, the surface type sensors 114 may only be activated when the robotic cleaner 100 is engaging in wet cleaning (e.g., the pad 128 is wet). This may result in reduced power consumption and/or reduce the processing load of the controller 130. In other instances, the forward sensors 114 may be active in both wet and dry cleaning operations. In these instances, the forward sensors 114 may also be used to detect a drop-off in a surface (e.g., an edge of a stair).

The one or more forward sensors 114 can be infrared (IR) sensors configured to emit an IR beam using an IR light emitting diode (LED) and to detect light reflected from a surface to be cleaned. Moreover, the one or more forward sensors 114 may be used for cliff/stair detection. A single IR emitter may be used in combination with one or more IR detectors. Reflected light may have a sufficiently predictable optical signature (e.g., amplitude and/or frequency distribution) to allow the robotic cleaner 100 to determine a surface type based, at least in part, on a difference in the reflected signal received by one or more IR detectors. However, different surface types, such as dark carpets or shiny hard floors can decrease the accuracy of the surface type determination. The decrease in accuracy of the surface type determination may be mitigated by using additional sensors and/or comparisons to surrounding surface type determinations.

In some embodiments, the one or more drive wheel sensors 123, the one or more agitator motor sensors 127, and/or one or more side brush sensors 134 may be used in the determination of surface type in addition to, or in the alternative to, the one or more forward sensors 114. One or more of the one or more drive wheel sensors 123, the one or more agitator motor sensors 127, and/or one or more side brush sensors 134 may be positioned within a distance measuring less than or equal to two times a maximum width, or diameter, of a corresponding motor.

Output of the sensors 123, 127, and 134 may generally be described as being configured for use in safety and/or navigation. In other words, the robotic cleaner 100 may include the sensors 123, 127, and 134 primarily for safety and/or navigation purposes. For example, a current sensor may prevent an overcurrent event in an associated motor, while a wheel encoder may be used to determine distance traveled or wheel slippage during navigation. However, output from the sensors 123, 127, and 134 may also be used for surface type detection. For example, output from the sensors 123, 127, and 134 may vary based on surface type being traversed. In one example, as the robotic cleaner 100 traverses from hard floor to a plush carpet, the side brush motor 116 may experience an increase in torque and/or current draw. As such, the change in torque and/or current draw may be indicative of a change in surface type.

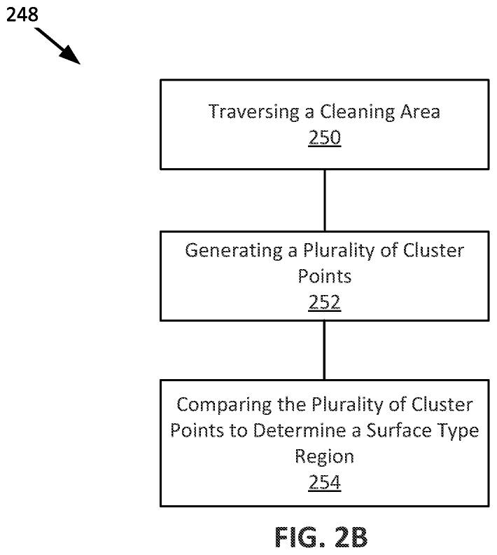

FIG. 2A shows an example of a schematic circuit diagram in which the surface type sensor 114 is employed to determine a surface type. As shown, the controller 130 includes or is communicatively coupled to an integration module 200. The integration module 200 is communicatively coupled to one or more of the forward sensors 114, the agitator sensor(s) 127, the drive wheel sensor(s) 123, and/or the side brush sensor(s) 134. For example, the integration module 200 can be configured to receive a first output from at least one forward sensor 114 and associate the first output with location data 144. The location data 144 corresponds to a location of the robotic cleaner 100 within an area being cleaned when the first output is generated. The association of the first output with the location data 144 may generally be described as a first cluster point. The controller 130 is configured to associate a surface type with the cluster point based, at least in part, on the first output. A confidence value may be associated with each cluster point generated, the confidence value being generally representative of a confidence that the surface type associated with the cluster point accurately represents the actual surface type.

In some instances, the first output may be compared to a second output. The second output may be generated by one or more of the forward sensors 114, the agitator sensor(s) 127, the drive wheel sensor(s) 123, and/or the side brush sensor(s) 134. The comparison result may be used in the generation of the confidence value.

The controller 130 is configured to compare the most recently generated cluster point with previously generated cluster points. Based, at least in part, on this comparison, a confidence value may be assigned to the most recently generated cluster point. The previously generated cluster points are associated with corresponding location data. In some instances, the most recently generated cluster point may be compared with previously generated cluster points having corresponding location data that is proximate the location data 144 (e.g., within 1 centimeter (cm), 5 cm, 10 cm, 50 cm, 100 cm, and/or the like). For example, the confidence value associated with the most recently generated cluster point may be based, at least in part, on the comparison of the most recently generated cluster point with one or more proximate cluster points.

After traversing a cleaning area, the controller 130 may analyze each of the generated cluster points. When a sufficient number of proximate cluster points correspond to the same surface type, the controller 130 may be configured to identify a surface type region. The surface type region may generally be described as being defined by a bounding line (e.g., in the form of a bounding box) that extends around an area having a sufficient quantity of cluster points that are associated with a common surface type. For example, when a density of cluster points associated with a common surface type exceeds a threshold value within a region, a surface type region may be established. The cluster point density of cluster points associated with a common surface type may generally be described as a quantity of cluster points having a common surface type within a region (e.g., proximate cluster points having a common surface type) divided by all cluster points within the region (e.g., all proximate cluster points). The threshold cluster point density for establishing a surface type region may be, for example, greater than 0.4, greater than 0.5, greater than 0.6, greater than 0.7, greater that 0.8, greater than 0.9, greater than 0.95, greater than 0.99, and/or any other threshold. The surface type region may correspond to, for example, an area rug situated within a tiled room, a carpeted room (e.g., adjacent a hard floor), and/or any other region.

Generation of a surface type region based, at least in part, on cluster point density may mitigate the impact of erroneous sensor outputs on the identification of surface types. In some instances, the controller 130 can be configured to filter out erroneous outputs (e.g., a false positive that erroneously indicates a change in surface type) based, at least in part, on a comparison of proximate cluster points. Additionally, or alternatively, the controller 130 may be configured to filter out erroneous outputs based, at least in part, on the confidence value associated with a respective cluster point.

FIG. 2B is a flow chart of an example of a method of surface type detection 248. The method 248 may be carried out, for example, by the robotic cleaner 100 of FIG. 1. The method 248 may be embodied as one or more instructions stored in one or more memories (e.g., non-transitory computer readable memories), wherein the one or more instructions are configured to be executed on one or more processors. For example, a controller may be configured to cause one or more steps of the method 248 to be carried out. Additionally, or alternatively, one or more steps of the method 248 may be carried out in any combination of software, firmware, or circuitry (e.g., an application-specific integrated circuit).

As shown, the method 248 includes an operation 250. The operation 250 may include causing the robotic cleaner to traverse a cleaning area. While traversing the cleaning area the robotic cleaner may carry out one or more cleaning operations. Alternatively, while traversing the cleaning area, the robotic cleaner may not carry out any cleaning operations.

The method 248 also includes an operation 252. The operation 252 may include generating a plurality of cluster points while traversing the cleaning area. Each cluster point is associated with a surface type and a location. The location corresponds to a location within the cleaning area at which the surface type for the cluster point was determined.

The method 248 includes the operation 254. The operation 254 may include determining at least one surface type region within the cleaning area based, at least in part, on a comparison of the plurality of cluster points. Each surface type region may be determined by comparing proximate cluster points. The comparison of proximate cluster points may include a comparison of surface types of the corresponding cluster points. Proximate cluster points may include cluster points within, for example, 1 cm, 5 cm, 10 cm, 50 cm, 100 cm of a location.

In some instances, the comparison of proximate cluster points may include determining a cluster point density of proximate cluster points and comparing the cluster point density to a threshold. The cluster point density may generally be described as a quantity of proximate cluster points associated with a common surface type (e.g., carpet, hard floor, or any other surface type) divided by a total quantity of proximate cluster points.

FIG. 3 shows a bottom view of an example of a robotic wet/dry cleaner 300, which may be an example of the robotic cleaner 100 of FIG. 1. As shown, the robotic wet/dry cleaner 300 includes a plurality of side brushes 302, a plurality of drive wheels 304, an air inlet 306 having a rotatable agitator 308 therein, a forward non-driven wheel 310, a rearward non-driven wheel 312, a dust cup 314, a pad 316 removably coupled to the dust cup 314, and a plurality of surface type sensors 318 (e.g., a left surface type sensor 318a and a right surface type sensor 318b). The plurality of side brushes 302 may be driven by corresponding side brush motors 320 (shown schematically in hidden lines), the plurality of drive wheels 304 may be driven by corresponding drive motors 322 (shown schematically in hidden lines), and the rotatable agitator 308 may be rotated by a corresponding agitator motor 324 (shown schematically in hidden lines). The robotic wet/dry cleaner 300 may further include a suction motor 326 (shown schematically in hidden lines) configured to cause a suction force to be generated at the air inlet 306 such that debris deposited on a surface to be cleaned (e.g., a floor) may be urged therefrom.

The surface type sensors 318 may be spaced apart from the pad 316 by a distance sufficient to permit the robotic wet/dry cleaner 300 to determine (e.g., using a controller 328, shown schematically in hidden lines) a transition in surface type and alter its heading before the pad 316 reaches the transition. Such a configuration may prevent the pad 316 from contacting an adjacent surface type. For example, a sensor-pad separation distance 330 may measure in a range of 100 millimeters (mm) to 150 mm. By way of further example, the sensor-pad separation distance 330 may measure 130 mm. In some instances, a sensor separation distance 332 may be configured to be maximized while still having the sensor-pad separation distance 330 be of a sufficient magnitude to allow the robotic cleaner 300 to change direction and prevent the pad 316 from traversing a detected transition in surface type.

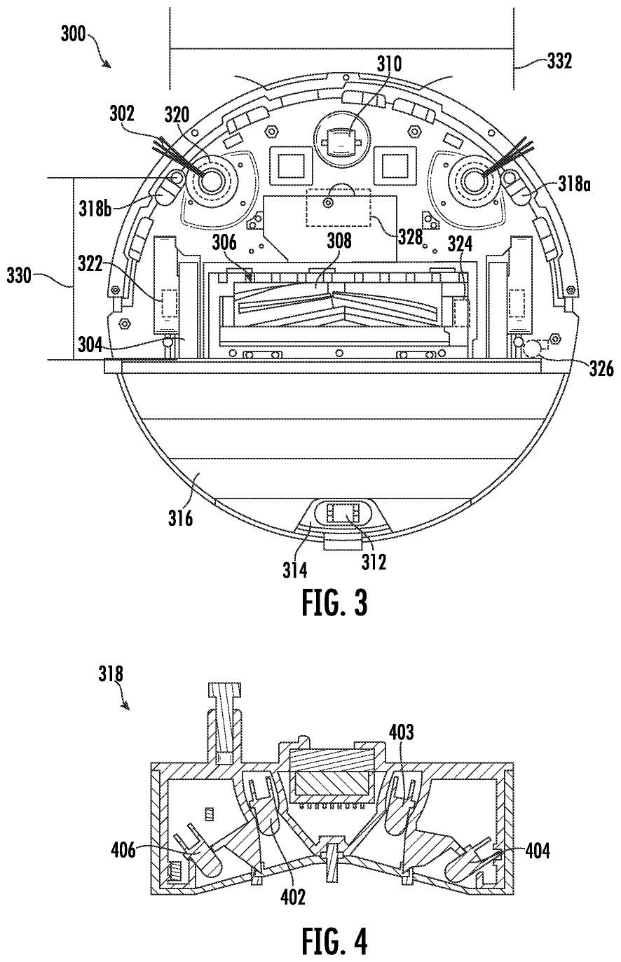

FIG. 4 shows a vertical cross-sectional view of an embodiment of the surface type sensor 318. As shown, the surface type sensor 318 includes an emitter 403 (e.g., an IR LED), a cliff sensor 402, a first surface type receiver 404, and a second surface type receiver 406. Other surface type sensors may include an ultrasonic sensor, an acoustic sensor, an optical flow sensor or any other optical sensor. Outputs from the first surface type receiver 404 and the second surface type receiver 406 may be used to determine a surface type over which a robotic cleaner is traversing. The behavior of the robotic wet/dry cleaner 300 may be adjusted based on the surface type detected. However, determinations of a surface type based on a single surface type sensor 318 output may result in erroneous outputs. If erroneous outputs occur, the robotic cleaner may expend additional computational resources in surface avoidance (e.g., may stop, change its route, or display behavior that a user would interpret as unintelligent).

In order to correct for the occurrences of erroneous outputs, the controller 328 may establish surface type regions based, at least in part, on cluster points generated using location data and outputs from the surface type sensor 318. As discussed, the surface type regions may be established based, at least in part, on a sufficient quantity of proximate cluster points being associated with a common surface type.

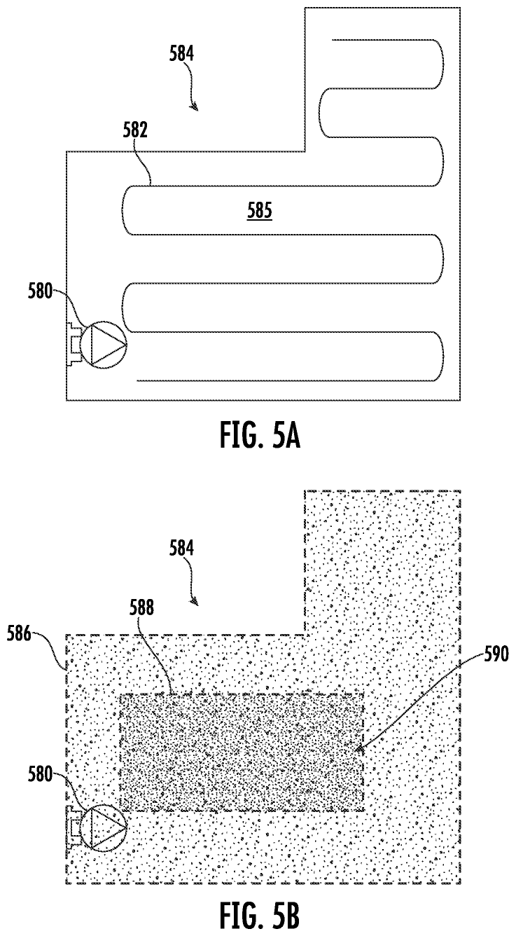

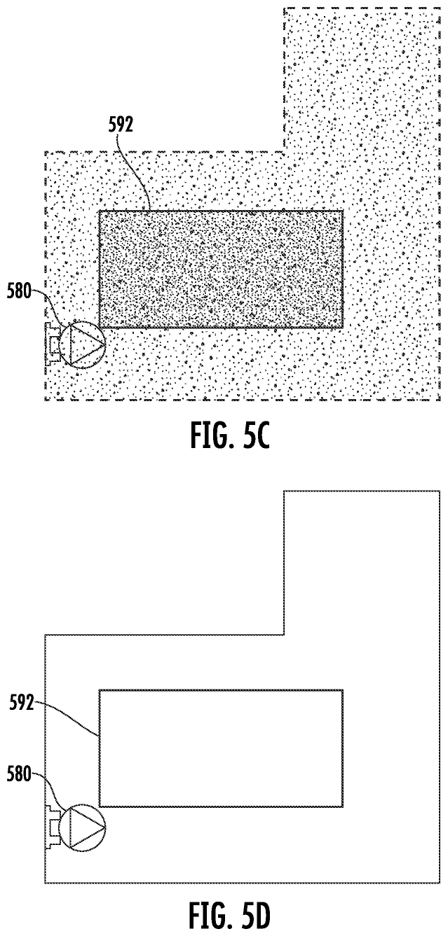

FIGS. 5A-5D illustrate the steps that a robotic cleaner 580 (which may be an example of the robotic cleaner 100 of FIG. 1) may use to determine a surface type region based, at least in part, on a sufficient quantity of proximate cluster points being associated with a common surface type. The steps illustrated in FIGS. 5A-5D may be carried out during a non-cleaning operation or a dry cleaning operation. As such, an initial map can be generated, the initial map may form the basis of a persistent map. A persistent map may generally be described as a map that is used by the robotic cleaner 580 during multiple cleaning operations.

FIG. 5A shows a movement path 582 of the robotic cleaner 580 within a cleaning area 584 having a surface to be cleaned (e.g., floor) 585. As shown, the movement path 582 is configured such that the robotic cleaner 580 traverses a substantial portion of the cleaning area 584 (e.g., greater than 75% of the cleaning area 584, greater than 85% of the cleaning area 584, greater than 90% of the cleaning area 584, greater than 95% of the cleaning area 584, and/or the like). While traversing the movement path 582, the robotic cleaner 580 may encounter at least two different surface types.

As shown in FIG. 5B, the cleaning area 584 includes a first surface type 586 (e.g., a hard floor) and a second surface type 588 (e.g., a carpeted floor). The first and second surface types 586 and 588 are shown schematically in dotted lines. While traversing the cleaning area 584, the robotic cleaner 580 generates cluster points 590, each cluster point 590 being associated with a corresponding surface type and location. For clarity, only cluster points 590 associated with the second surface type 588 are shown in FIG. 5B. As shown, the cleaning area 584 corresponding to the first surface type 586 erroneously includes cluster points 590 that correspond to the second surface type 588. These erroneous cluster points 590 may be, for example, the result of noise in the surface type sensor outputs and/or a condition of the surface.

The robotic cleaner 580 can be configured (e.g., using an algorithm) to identify a location of the first surface type 586 and the second surface type 588. For example, a location of the second surface type 588 within the cleaning area 584 may be based, at least in part, on a density of the cluster points 590 corresponding to the second surface type 588 within a region. In other words, an algorithm can be used to find regions having a sufficient quantity of cluster points 590 corresponding to the second surface type (e.g., at least 60%, at least 70%, at least 80%, at least 90%, at least 95%, or at least 99% of the cluster points 590 within the region correspond to the second surface type 588).

In some instances, the robotic cleaner 580 may be configured to identify only two surface types (e.g., hard floor and soft floor). In this instance, each cluster point may be associated with a binary representation of surface type (e.g., 0 for hard floor and 1 for soft floor).

As shown in FIG. 5C, once a region corresponding to the second surface type 506 is identified, the robotic cleaner 580 may identify a bounding line 592 that encloses the identified region (e.g., a bounding box). By enclosing the identified region with the bounding line 592, the robotic cleaner 580 may be able to delete the individual cluster points 590, which may reduce memory consumption (see, e.g., FIG. 5D).

In future cleaning operations, particularly in wet cleaning operations, the bounding line 592 may be used to identify regions in which the robotic cleaner 580 will not traverse (e.g., carpeted regions) during some or all cleaning operation. These regions may generally be described as keep-out regions.

Similarly, keep-out regions may also be established based on obstacle detection. For example, in regions having a large number of obstacles (e.g., a sufficient quantity to interfere with efficient traversal) the robotic cleaner 580 may experience several obstacle detections during a traversal. Based, at least in part, on the number of obstacle detections, the robotic cleaner 580 may establish a keep-out region that corresponds to those regions having a large number of obstacles in order to avoid getting stuck or entangled within the region during future traversals.

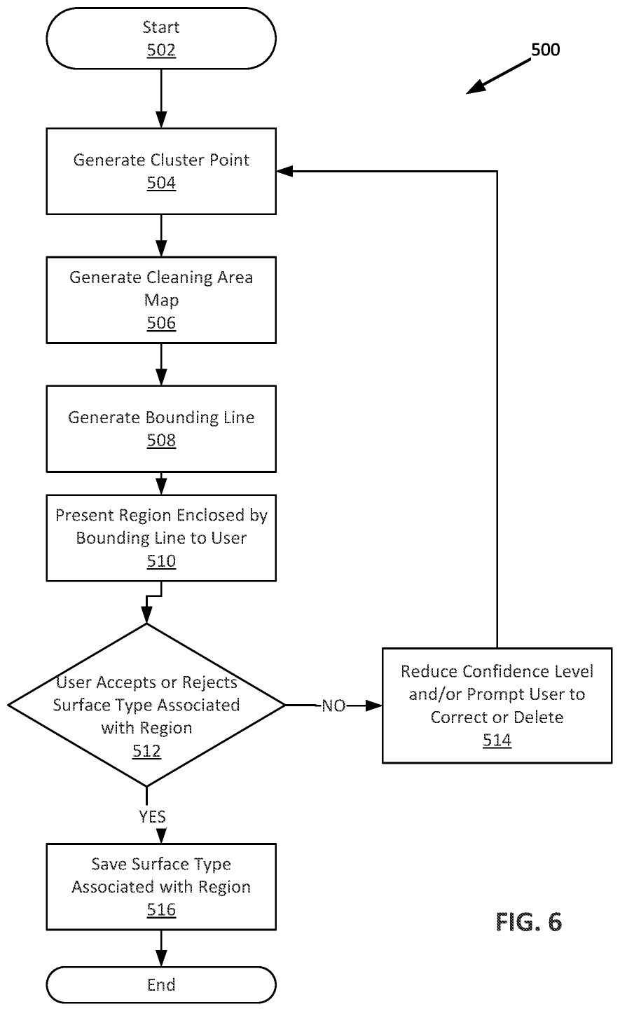

FIG. 6 shows a flow chart of an example of a method of surface type detection 500 using, for example, a robotic cleaner (e.g., the robotic cleaner 100 of FIG. 1) having a surface type sensor and a navigation system. The method 500 may be embodied as one or more instructions stored in one or more memories (e.g., non-transitory computer readable memories), wherein the one or more instructions are configured to be executed on one or more processors. For example, a controller may be configured to cause one or more steps of the method 500 to be carried out. Additionally, or alternatively, one or more steps of the method 500 may be carried out in any combination of software, firmware, or circuitry (e.g., an application-specific integrated circuit).

During operation 502, the robotic cleaner is caused to traverse a cleaning area using the navigation system. The navigation system is configured localize the robotic cleaner within the cleaning area (e.g., such that the robotic cleaner can determine its position within the cleaning area). While traversing the cleaning area, the surface type sensor outputs a signal corresponding to a surface type on which the robotic cleaner is traveling. Based, at least in part, on the surface type sensor output, the controller may determine a surface type over which the robotic cleaner is traveling and associate a confidence level with the determined surface type.

During operation 504, the controller associates the determined surface type with a location, forming a cluster point. The location associated with the surface type corresponds to the location where the surface type sensor output the signal corresponding to the surface type, as determined by the navigation system. The controller may continue to generate cluster points while the robotic cleaner traverses the cleaning area.

During operation 506, a map of the cleaning area may be generated (e.g., by the controller of the robotic cleaner and/or by a remote device), wherein the map includes the cluster points (e.g., the map displays of a location of each cluster point generated that is associated with a specific surface type). For example, the generated map may be configured to show cluster points that correspond to soft surface types (e.g., carpet).

During operation 508, a bounding line location can be determined (e.g., by the controller of the robotic cleaner and/or by a remote device). The bounding line is configured to enclose (e.g., within a box) regions having a sufficient number of cluster points associated with a specific surface type (e.g., carpet). For example, a bounding box may be established that encloses a region having a cluster point density, for cluster points associated with a carpet surface type, that exceeds a predetermined threshold.

During operation 510, the region enclosed by the bounding line may also be presented visually to a user of the robotic cleaner (e.g., using a remote device such as a smartphone, tablet, computer, and/or any other device). When presented to the user, the region enclosed by the bounding line may also be associated with a surface type (e.g., the surface type associated with the cluster points having a cluster point density in excess of a threshold).

During operation 512, the user can confirm that the surface type associated with the enclosed region is accurate or reject the surface type associated with the enclosed region as being inaccurate. During operation 516, if the user accepts the surface type, the bounding line and surface type associated with the region enclosed by the bounding line may be saved for future cleaning operations. This may allow the cluster points to be deleted, saving memory. During operation 514, if the user rejects the surface type, the user may be prompted to select a correct surface type, the user may be prompted to delete the bounding line and/or cluster points, and/or a confidence level associated with the surface type determination may be reduced.

In some instances, one or more additional sensors, in addition to the surface type sensor, may be used to determine surface type. The surface type determined using the one or more additional sensors may be compared to the surface type determined using the surface type sensor. Based on the comparison, the controller may determine a surface type to be associated with a respective cluster point and a confidence value to be associated with the associated surface type. The one or more additional sensors may be less reliable than the surface type sensor when determining surface type.

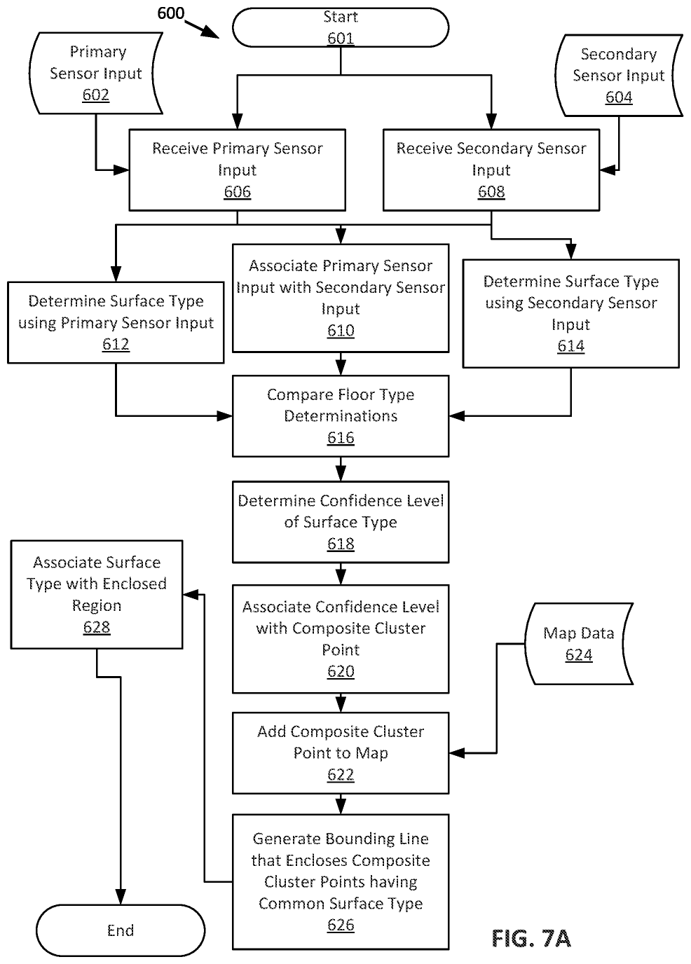

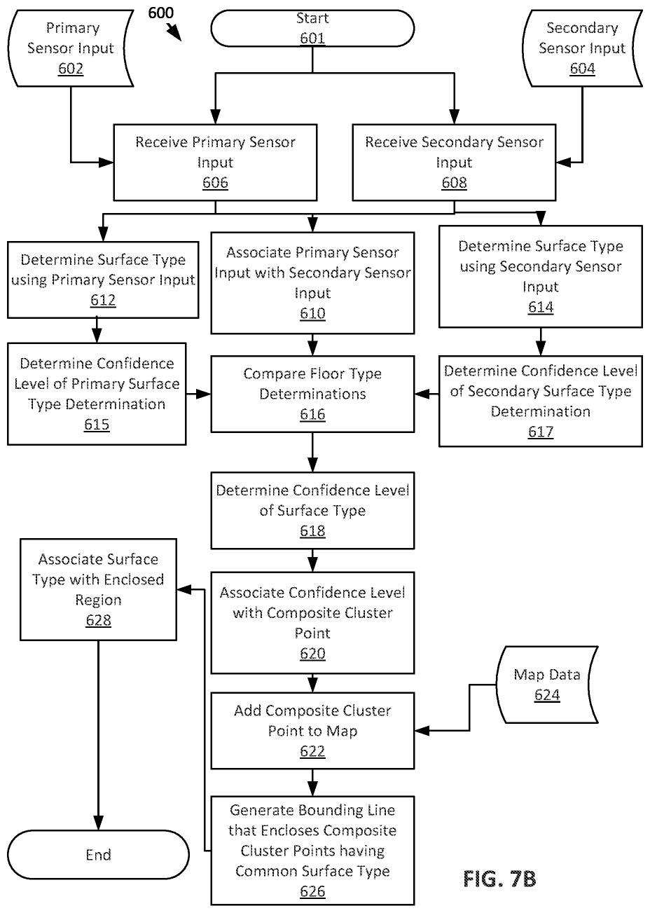

FIG. 7A shows a flow chart of an example of a method of surface type detection 600 using, for example, a robotic cleaner (e.g., the robotic cleaner 100 of FIG. 1) having a surface type sensor and a navigation system. The method 600 may be embodied as one or more instructions stored in one or more memories (e.g., non-transitory computer readable memories), wherein the one or more instructions are configured to be executed on one or more processors. For example, a controller may be configured to cause one or more steps of the method 600 to be carried out. Additionally, or alternatively, one or more steps of the method 600 may be carried out in any combination of software, firmware, or circuitry (e.g., an application-specific integrated circuit).

During operation 601, a robotic cleaner is caused to traverse a cleaning area using a navigation system. While traversing the cleaning area, a primary sensor (e.g., a surface type sensor) is configured to generate a primary sensor input (or output) 602 and a secondary sensor (e.g., a sensor associated with a drive motor, a side brush motor, or an agitator motor) is configured to generate a secondary sensor input (or output) 604. The primary sensor input 602 and the secondary sensor input 604 correspond to a location within the cleaning area.

At operation 606, a controller of the robotic cleaner receives the primary sensor input 602. The controller associates the corresponding location with the primary sensor input 602, forming a first sensor cluster point. At operation 608, the controller of the robotic cleaner receives the secondary sensor input 604. The controller associates the corresponding location with the secondary sensor input 604, forming a second sensor cluster point.

During operation 612, a surface type corresponding to the primary sensor input 602 is determined and associated with the first sensor cluster point. During operation 614, a surface type corresponding to the secondary sensor input 604 is determined and associated with the second sensor cluster point. During operation 616, the surface types associated with the first and second cluster points are compared. At operation 610, the controller associates the first and second sensor cluster points corresponding to a common location within the cleaning area to form a composite cluster point that is associated with the common location. In some instances, the generation of composite cluster point may generally be described as being based, at least in part, on a comparison of a first sensor cluster point with a second sensor cluster point wherein, the first sensor cluster point is generated using the primary sensor input 602 and the second sensor cluster point is generated using the secondary sensor input 604.

During operation 618, a confidence level of the composite cluster point is determined based, at least in part, on the comparison. For example, when both the first and second cluster points are associated with the same surface type, the determined confidence level is higher than if the first and second cluster points are associated with different surface types.

During operation 620, the controller associates the confidence level of the composite cluster point with the composite cluster point. During operation 622, a map is generated using map data 624 and the composite cluster point. The map data 624 may be generated using the navigation system of the robotic cleaner. The composite cluster point is added to the generated map at the location associated with the composite cluster point. Operations 606, 608, 610, 612, 614, 616, 618, 620, and 622 may be repeated until a substantial portion of the cleaning area is traversed.

During operation 626, the controller generates a bounding line that encloses a region having a sufficient quantity of composite cluster points associated with a common surface type. Operation 626 may be performed during and/or after a robotic cleaner traverses the cleaning area. At operation 628, a surface type is associated with the region enclosed by the boundary line, the surface type corresponds to the common surface type of the composite cluster points.

FIG. 7B is a flow chart of an example of the method of surface type detection 600, wherein the primary sensor input 602 is received from a surface type sensor (e.g., an optical or IR surface type sensor) and the secondary sensor input 604 is received from one or more sensors associated with a respective side brush motor, agitator motor, and/or drive wheel motor (e.g., a sensor that measures current draw or torque of the corresponding motor). In this example, reliability of a detected surface type using the primary sensor input 602 may be greater than the reliability of a detected surface type using the secondary sensor input 604. A confidence level may be associated with the primary sensor input 602 and the secondary sensor input 604.

The confidence level for each sensor may be based, at least in part, on a magnitude in a change in sensor output. When the robotic cleaner traverses a transition in surface type, a magnitude of change in sensor outputs may be different based on the surface types. For example, when transitioning from a low-pile carpet to a hard, reflective, floor the optical sensor may experience a larger magnitude of change in output when compared to a magnitude of change in an output from a sensor measuring side brush torque. As such, a higher confidence may be associated with the output from the optical sensor and a lower confidence may be associated the output generated by the sensor measuring side brush torque.

As shown in FIG. 7B, the method 600 may include the additional operations 615 and 617. In operation 615, a confidence level (e.g., represented as a reliability factor) may be assigned to the surface type determined from the primary sensor input 602. In operation 617, a confidence level (e.g., represented as a reliability factor) may be assigned to the surface type determined from the secondary sensor input 604. During operation 616, the confidence levels assigned to each surface type determination may be considered during the comparison. For example, a weight may be assigned to each surface type determination, wherein the weight is based, at least in part, on the confidence level.

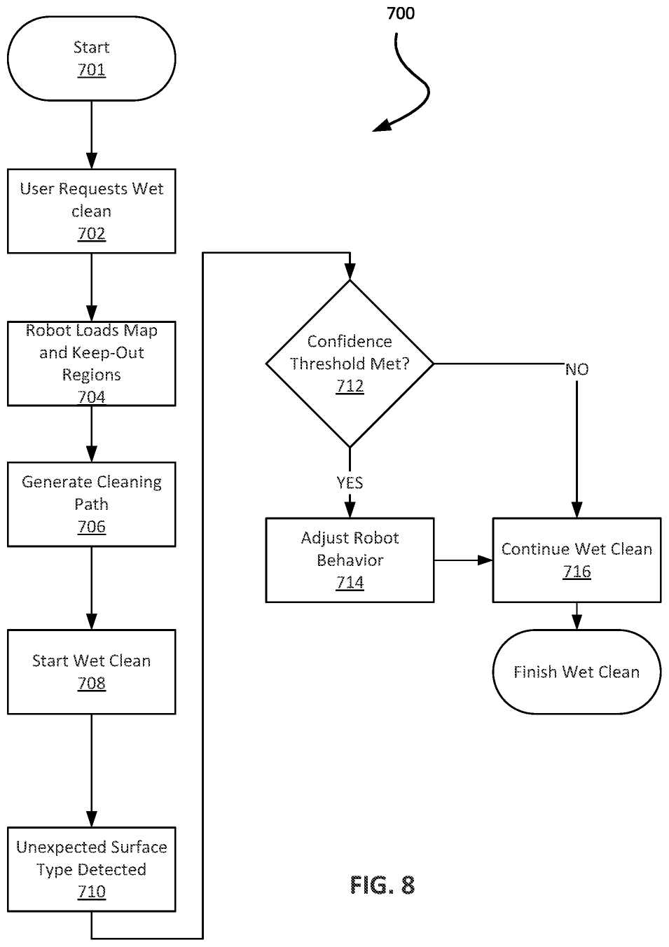

FIG. 8 shows a flow chart of an example of a method of surface type detection during a cleaning operation 700 (e.g., a wet cleaning operation). The method 700 may be carried out after the methods of FIGS. 5A-5D, 7A, and 7B have been carried out and an initial surface type map has been established. As such, the method 700 may generally be described as a dynamic surface type assessment, which may allow the robotic cleaner to adjust its behavior based on changes that occurred in the environment since the initial surface type map was developed.

The method 700 may be embodied as one or more instructions stored in one or more memories (e.g., non-transitory computer readable memories), wherein the one or more instructions are configured to be executed on one or more processors. For example, a controller may be configured to cause one or more steps of the method 700 to be carried out. Additionally, or alternatively, one or more steps of the method 700 may be carried out in any combination of software, firmware, or circuitry (e.g., an application-specific integrated circuit).

At operation 701, the robotic cleaner receives a cleaning request from a user (e.g., from a remote device or an input at user interface on the robotic cleaner). In some instances, the robotic cleaner may receive a generic cleaning request (e.g., a request that does not specify wet or dry cleaning). In these instances, a type of cleaning operation may be determined based, at least in part, on what module (e.g., a wet cleaning module) is coupled to the robotic cleaner. In some instances, insertion of a cleaning module may be the cleaning request.

At operation 702, the robotic cleaner determines the type of request received (e.g., wet cleaning request or dry cleaning request). At operation 704, if a wet cleaning request is received, the robotic cleaner is caused to load the initial surface type map and associates keep-out regions with carpeted regions. In some instances, the robotic cleaner may also associate keep-out regions with areas having high obstacle detection rates.

At operation 706, a navigation system of the robotic cleaner generates a cleaning path. The generated cleaning path is configured to cause the robotic cleaner to avoid keep-out regions. In some instances, the navigation system may be configured to determine and generate the most efficient cleaning path for cleaning the cleaning area.

At operation 708, the cleaning robot is caused to traverse the generated cleaning path while carrying out a wet cleaning operation. During operation 708, the robotic cleaner may be configured to detect unexpected changes in surface type while traversing the cleaning path. The unexpected changes in surface type may generally be described as changes that are not represented in the initial surface type map.

At operation 710, when an unexpected change in surface type is detected, the robotic cleaner determines a confidence level associated with the change in surface type. At operation 712, the robotic cleaner determines whether the confidence level meets or exceeds a predetermined threshold. At operation 714, if the confidence level meets or exceeds a predetermine threshold, the robotic cleaner will adjust its planned path to avoid the transition in surface type. For example, if the robotic cleaner has a high level of confidence that a new carpet has been detected, the robotic cleaner will adjust its behavior to avoid traversing the carpet during wet cleaning. Any new transitions in surface type detected during a cleaning operation may be added to the initial map for use in later cleaning operations to establish one or more keep-out regions. A transition in surface type may be determined when, for example, the robotic cleaner detects the new surface type multiple times within a predetermined time and/or region. At operation 716, if the confidence level does not meet or exceed the threshold, the robotic cleaner will assume the detected transition in surface type was erroneous and will continue traversing the cleaning path, ignoring the erroneous transition in surface type.

An example of a method of surface type detection, consistent with the present disclosure, may include traversing a cleaning area, generating a plurality of cluster points while traversing the cleaning area, each cluster point being associated with a corresponding surface type and a location, and determining at least one surface type region within the cleaning area based, at least in part, on a comparison of the plurality of cluster points.

In some instances, determining the at least one surface type region may include comparing proximate cluster points. In some instances, determining the at least one surface type region may include determining a cluster point density for proximate cluster points and comparing the cluster point density to a threshold. In some instances, the cluster point density may be a quantity of proximate cluster points associated with a common surface type divided by a total quantity of proximate cluster points. In some instances, the common surface type may be carpet. In some instances, each cluster point may be associated with a confidence value. In some instances, the confidence value may be determined based, at least in part, on a comparison of proximate cluster points. In some instances, the plurality of cluster points may be composite cluster points, each composite cluster point being generated based, at least in part, on a comparison of a first sensor cluster point with a second sensor cluster point, the first sensor cluster point being generated using a first sensor output that is generated by a first sensor and the second sensor cluster point being generated using a second sensor output that is generated by a second sensor, the first and second sensors being different. In some instances, the first sensor output and the second sensor output may be each associated with a corresponding confidence value. In some instances, the method may further include generating a map of the cleaning area, the map including the plurality of cluster points.

An example of a robotic cleaner, consistent with the present disclosure, may include at least one driven wheel driven by a drive motor, at least one side brush driven by a side brush motor, a surface type sensor, and a controller, the controller being configured to carry out a method of surface type detection. The method may include causing the robotic cleaner to traverse a cleaning area, generating, using the surface type sensor, a plurality of cluster points while traversing the cleaning area, each cluster point being associated with a corresponding surface type and a location, and determining at least one surface type region within the cleaning area based, at least in part, on a comparison of the plurality of cluster points.

In some instances, determining the at least one surface type region may include comparing proximate cluster points. In some instances, determining the at least one surface type region may include determining a cluster point density for proximate cluster points and comparing the cluster point density to a threshold. In some instances, the cluster point density may be a quantity of proximate cluster points associated with a common surface type divided by a total quantity of proximate cluster points. In some instances, the common surface type may be carpet. In some instances, each cluster point may be associated with a confidence value. In some instances, the confidence value may be determined based, at least in part, on a comparison of proximate cluster points. In some instances, the plurality of cluster points may be composite cluster points, each composite cluster point being generated based, at least in part, on a comparison of a first sensor cluster point with a second sensor cluster point, the first sensor cluster point being generated using a surface type sensor output that is generated by the surface type sensor and the second sensor cluster point being generated using a second sensor output that is generated by a second sensor that is associated with one of the drive motor or the side brush motor. In some instances, the surface type sensor output and the second sensor output may be each associated with a corresponding confidence value. In some instances, the method may further include generating a map of the cleaning area, the map including the plurality of cluster points.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method of surface type detection comprising:
traversing a cleaning area;
generating a plurality of cluster points while traversing the cleaning area, each cluster point being associated with a corresponding surface type and a location; and
determining at least one surface type region within the cleaning area based, at least in part, on a comparison of the plurality of cluster points.

2. The method of claim 1, wherein determining the at least one surface type region includes comparing proximate cluster points.

3. The method of claim 2, wherein determining the at least one surface type region includes determining a cluster point density for proximate cluster points and comparing the cluster point density to a threshold.

4. The method of claim 3, wherein the cluster point density is a quantity of proximate cluster points associated with a common surface type divided by a total quantity of proximate cluster points.

5. The method of claim 4, wherein the common surface type is carpet.

6. The method of claim 1, wherein each cluster point is associated with a confidence value.

7. The method of claim 6, wherein the confidence value is determined based, at least in part, on a comparison of proximate cluster points.

8. The method of claim 1, wherein the plurality of cluster points are composite cluster points, each composite cluster point being generated based, at least in part, on a comparison of a first sensor cluster point with a second sensor cluster point, the first sensor cluster point being generated using a first sensor output that is generated by a first sensor and the second sensor cluster point being generated using a second sensor output that is generated by a second sensor, the first and second sensors being different.

9. The method of claim 8, wherein the first sensor output and the second sensor output are each associated with a corresponding confidence value.

10. The method of claim 1 further comprising generating a map of the cleaning area, the map including the plurality of cluster points.

11. A robotic cleaner comprising:
at least one driven wheel driven by a drive motor;
at least one side brush driven by a side brush motor;
a surface type sensor; and
a controller, the controller being configured to carry out a method of surface type detection, the method comprising:
causing the robotic cleaner to traverse a cleaning area;
generating, using the surface type sensor, a plurality of cluster points while traversing the cleaning area, each cluster point being associated with a corresponding surface type and a location; and
determining at least one surface type region within the cleaning area based, at least in part, on a comparison of the plurality of cluster points.

12. The robotic cleaner of claim 11, wherein determining the at least one surface type region includes comparing proximate cluster points.

13. The robotic cleaner of claim 12, wherein determining the at least one surface type region includes determining a cluster point density for proximate cluster points and comparing the cluster point density to a threshold.

14. The robotic cleaner of claim 13, wherein the cluster point density is a quantity of proximate cluster points associated with a common surface type divided by a total quantity of proximate cluster points.

15. The robotic cleaner of claim 14, wherein the common surface type is carpet.

16. The robotic cleaner of claim 11, wherein each cluster point is associated with a confidence value.

17. The robotic cleaner of claim 16, wherein the confidence value is determined based, at least in part, on a comparison of proximate cluster points.

18. The robotic cleaner of claim 11, wherein the plurality of cluster points are composite cluster points, each composite cluster point being generated based, at least in part, on a comparison of a first sensor cluster point with a second sensor cluster point, the first sensor cluster point being generated using a surface type sensor output that is generated by the surface type sensor and the second sensor cluster point being generated using a second sensor output that is generated by a second sensor that is associated with one of the drive motor or the side brush motor.

19. The robotic cleaner of claim 18, wherein the surface type sensor output and the second sensor output are each associated with a corresponding confidence value.

20. The robotic cleaner of claim 11 further comprising generating a map of the cleaning area, the map including the plurality of cluster points.
